(19) United States
(12) Patent Application Publication
(10) Pub. No.: US 2025/0362181 A1
(43) Pub. Date: Nov. 27, 2025

(54) CONTACT/NON-CONTACT TEMPERATURE & DISTANCE SENSOR DEVICE

(71) Applicant: IV Thought Products & Design Corp., Buffalo, NY (US)

(72) Inventors: Samuel Lawrence MORRIS, III, Buffalo, NY (US); Andrew KOTTAGE, Columbia, SC (US); Bryan Alexander BERC, Boynton Beach, FL (US); Daniel L. WYNICK, Boynton Beach, FL (US); Joseph Thomas MORGENSTERN, Crownsville, MD (US); Hsu Ming Ming YI, Dongguan City (CN); Tian Zhan SHENG, Shenzhen City (CN); Lai Yung LIN, Dongguan City (CN); Fan De KUN, Shenzhen City (CN)

(21) Appl. No.: 19/215,258

(22) Filed: May 21, 2025

Related U.S. Application Data
(60) Provisional application No. 63/650,128, filed on May 21, 2024.

(51) Int. Cl. G01K 1/20; G01J 5/00; G01J 5/48; G01K 3/14

(52) U.S. Cl. CPC G01K 1/20; G01J 5/48; G01K 3/14; G01J 2005/0077

(57) ABSTRACT

A contact/non-contact temperature & distance sensor device having a light guidance system, a distance measurement unit, a non-contact type measurement unit, a contact type measurement unit, and a calculating unit that determines an object's actual hottest temperature in a particular region by (i) comparing the measured ambient air temperature to the measured hottest temperature in the object's particular region, and (ii) adjusting the measured hottest temperature in relation to the measured distance to determine the object's actual hottest temperature.

### BACKGROUND OF THE INVENTION

The present invention is directed toward measuring the temperature of an object. The object is, in most instances, a glass or borosilicate glass object that is being heated. To measure the actual temperature of the object, the distance between the temperature sensor device and the object must be determined. Measuring the distance with conventional infrared distance measurement technology is not practical because the infrared waves normally deflect or pass through the object. Accordingly, the present invention solves that distance measuring problem and uses that distance measurement with ambient temperature measurements and the object's recorded temperature to determine the object's actual temperature. Once the object's actual temperature is known, the user can adjust the object's temperature and/or position in relation to a thermal energy source to obtain a desired temperature.

### Temperature Measurements

Objects with a temperature above absolute zero emit electromagnetic radiation from their surface, that is proportional to their temperature. This radiation includes various measurable electromagnetic waves. And conventional non-contact temperature measurement devices can measure the object's infrared radiation since the infrared radiation is emitted into the surrounding atmosphere.

Each conventional non-contact temperature measurement device has temperature sensor. A common temperature sensor utilizes a lens to focus infrared radiation beams, transmitted from an object having its temperature measured, onto a temperature detector element. This temperature detector element then produces an electrical signal that is directly proportional to the amount of infrared radiation it receives.

The electrical signal undergoes amplification and can be converted into an output signal proportional to the object's temperature using standard digital signal processing techniques. This measured temperature can be displayed or transmitted as an analog output signal.

The advantages of using a non-contact temperature measurement device are clear. The non-contact temperature measurement device measures the temperature of moving objects, overheated objects, and objects in hazardous environments. Additionally, the non-contact temperature measurement device offers a non-destructive, non-interactive measurement, ensuring the measured object remains unaffected. The non-contact temperature measurement device also provides a durable measurement point and eliminates mechanical wear. However, it's important to acknowledge the potential drawbacks. Since the non-contact temperature measurement device does not directly contact the object, and relies on, in many instances, infrared radiation for measurement, its accuracy may be less reliable compared to contact-based methods and devices.

### Infrared

The electromagnetic spectrum encompasses a range of electromagnetic waves, each distinguished by its unique wavelength and frequency. Spanning approximately 23 orders of magnitude in wavelength, this spectrum exhibits variations in origin, generation, and application across different sectors. Despite these differences, all electromagnetic radiation adheres to the fundamental principles of diffraction, refraction, reflection, and polarization. Furthermore, under normal conditions, electromagnetic radiation propagates at the speed of light, and the product of its wavelength and frequency remains constant (λf=c).

Infrared radiation occupies a limited portion of the electromagnetic spectrum, ranging from approximately 0.78 μm to 1000 μm. Infrared temperature measurement primarily utilizes wavelengths between 0.7 μm and 14 μm. Wavelengths exceeding 14 μm possess energy levels too low for detection by conventional non-contact temperature measurement devices.

The concept of a black body is fundamental in physics. It is defined as an idealized physical body that absorbs all incident electromagnetic radiation, regardless of frequency or angle. The radiation emitted by a black body in thermal equilibrium with its environment is known as black-body radiation. The black body has no reflective or transmissive properties and emits the maximum possible energy at each wavelength. The radiation's concentration is independent of angle. Understanding black bodies is crucial for non-contact temperature measurement and infrared thermometer calibration.

The black body has a thermal hollow body with a small aperture at one end. When heated to a specific temperature, the interior of the hollow body reaches thermal equilibrium. At this point, the black body emits black-body radiation of that specific temperature from the aperture. The construction of these black bodies, including the materials used and the geometric structure, varies depending on the desired temperature range and application. It is important to note that if the aperture is very small compared to the overall surface area, interference with the ideal state is minimal.

### BRIEF DESCRIPTION OF THE FIGURES

FIG. 1 is a contact and non-contact temperature and non-contact distance sensor device in the operational state.

FIG. 2 is a flow chart of the contact and non-contact temperature and non-contact distance sensor device in the operational state.

FIG. 3 is the contact and non-contact temperature and non-contact distance sensor device in a transportation/storage state.

### DETAILED DESCRIPTION OF THE INVENTION

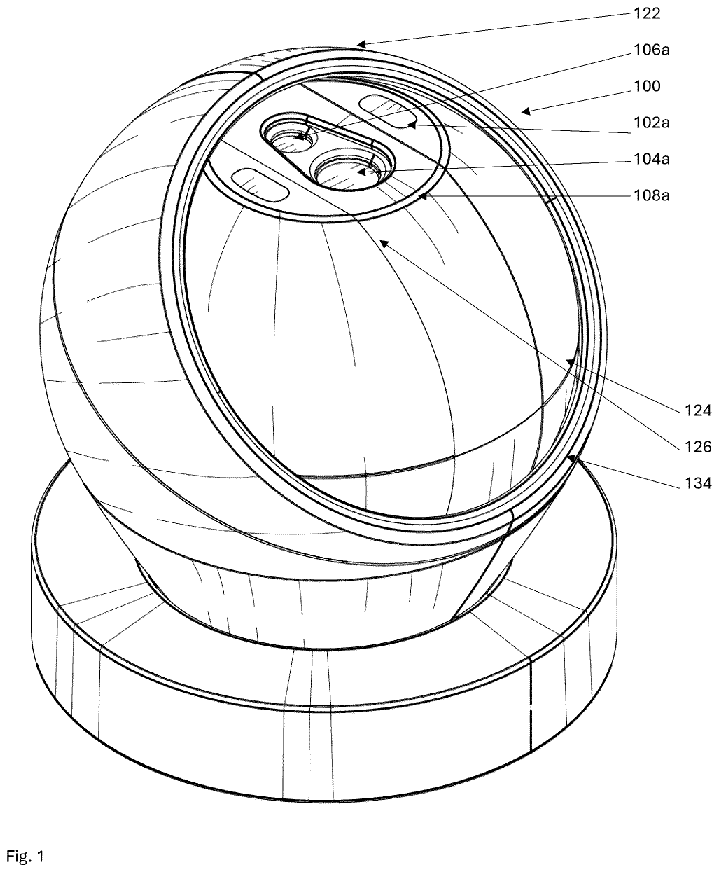

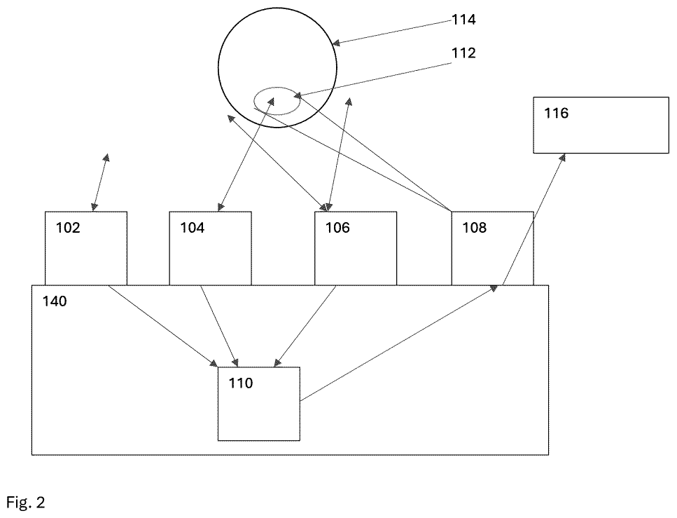

The present invention is directed toward a contact and non-contact temperature and non-contact distance sensor device 100 as shown in FIG. 1. This device is designed to accurately measure the temperature of an object 114 as shown in FIG. 2.

A temperature sensor measures an object's temperature and typically converts the readings into electrical signals for output. These sensors are categorized into two main types: contact and non-contact. Contact temperature sensors 102 include thermocouples, thermistors, and resistance thermometers, and are positioned in opening 102a. Non-contact temperature sensors 104 that are positioned in opening 104a.

### Contact Types

Thermocouples, electrical devices formed by two dissimilar electrical conductors, generate a temperature-dependent voltage due to the Seebeck effect—when two dissimilar materials are joined at two points and one point is heated, electrons (charge carriers) move from the hotter junction to the cooler junction, creating a voltage difference. This voltage difference is directly proportional to the temperature difference.—This voltage can then be interpreted to measure temperature. However, it's important to note that thermocouples have limitations in accuracy. Achieving system errors of less than one degree Celsius (C) can be challenging.

A thermistor is a type of resistor with semiconducting properties. Its resistance is highly dependent on temperature, significantly more so than standard resistors.

Thermistors and resistance temperature detectors (RTDs) differ in both the materials used and their temperature response. Thermistors typically employ ceramics or polymers, while RTDs utilize pure metals. Consequently, RTDs are effective across broader temperature ranges, whereas thermistors offer greater precision within a more limited range (usually −90° C. to 130° C.).

In this invention, a contact-type temperature sensor 102 measures ambient air temperature around the contact and non-contact temperature and non-contact distance sensor device 100 and transmits a corresponding electrical signal about the ambient temperature through a printed circuit board. This ambient temperature signal is then sent to either a memory unit (central processing unit) 110 on a printed circuit board positioned in the device 100 or a remote central processing unit.

The remote central processing unit can receive the electrical signal representing the ambient air temperature measurement through several methods:

A hard connection system where;
(i) The printed circuit board receives the electrical signal directly from the attached temperature sensor.
(ii) A conventional USB-C port, electrically attached to the printed circuit board, also receives the electrical signal.
(iii) A wire electrically connects the central processing unit to the USB-C port, enabling signal transmission.

A first wireless connection system, for example and not limited to, using conventional bluetooth technology, mobile communication technology, microwave communication technology, infrared communication technology, or wireless fidelity technology, where:
(i) The printed circuit board receives the electrical signal from the temperature sensor,
(ii) A conventional wireless communication device, attached to the printed circuit board, receives the signal and wirelessly transmits the signal to the central processing unit which also has a second corresponding wireless communication device.

A second wireless connection system where:
(i) The printed circuit board receives the electrical signal from the temperature sensor,
(ii) A conventional USB-C port, connected to both the printed circuit board and a wireless communication device, receives the signal. The wireless device then transmits the signal to the central processing unit which also has a second corresponding wireless communication device.

A third wireless connection system where:
(i) The printed circuit board receives the electrical signal from the attached temperature sensor.
(ii) A conventional USB-C port, connected to the printed circuit board and a wire, receives the signal.
(iii) A conventional wireless communication device, attached to the wire, receives the signal and wirelessly transmits it to the central processing unit which also has a second corresponding wireless communication device.

### Non-Contact Types

Non-contact types include infrared temperature sensors are designed with compact sensor heads and offer unlimited detecting distance. Their ease of installation in various positions and spaces makes them highly versatile. These sensors measure an object's temperature by detecting its emitted infrared radiation through the following process:
(A) A lens gathers and directs the infrared rays emitted by the object onto a sensing element, typically a thermopile.
(B) The thermopile absorbs these infrared rays, which raises its temperature and generates an electrical signal proportional to the temperature change.
(C) These electrical signals are then amplified and adjusted based on the object's emissivity-its efficiency in emitting thermal radiation. Air has an emissivity of 0, meaning infrared rays pass through or reflect off it. An object with an emissivity of 1 represents the maximum possible radiation, while most objects fall between 0 and 1. Following this correction, the temperature is displayed.

The thermopile's structure can consist of numerous thermocouples connected in series. The hot junctions of these thermocouples are centrally located, while the cold junctions are positioned along the periphery. The infrared rays collected by the lens impinge upon the hot junctions, causing them to heat up. Due to the Seebeck effect—the generation of an electromotive force at the junction of two different metals when a temperature difference exists-a voltage difference arises between the hot and cold junctions, enabling temperature measurement.

Infrared temperature sensors operate by measuring the intensity of radiant heat emitted by an object. There are three main categories of these sensors;
(i) Total radiation temperature sensors; These measure a temperature based on the total radiant energy across the entire wavelength spectrum.
(ii) Wide-band radiation temperature sensors: These measure a temperature using only a specific range of wavelengths.
(iii) One-color temperature sensors: These determine temperature based on the intensity of radiant heat at a single wavelength.

It's important to note that infrared temperature sensors cannot measure the internal temperature of a target or the temperature of gases. Additionally, the sensor's emissivity—the ratio of the energy radiated from a material's surface to that radiated from a perfect emitter, known as a blackbody, at the same temperature and wavelength and under the same viewing conditions—setting must be configured according to the target material.

In contrast, two-color temperature sensors utilize radiant heat at two different wavelengths and calculate temperature from the ratio of their radiances. A key advantage of two-color sensors is their reduced error margin, even when measuring targets smaller than the sensor's spot diameter. However, they can be less accurate in environments with dust, water vapor, or when measuring through a dirty window due to the scattering of radiant heat.

Our innovation lies in a non-contact-type temperature sensor designed to measure the hottest temperature within a specific, visually identified region 112 of an object 114. This visual confirmation is achieved through: (a) a multi-colored/programmable LED ring, (b) a solid-colored LED ring, (c) a set of LED dot lights (e.g., three forming a triangle, four forming a square), or (d) a series of laser diodes. Each of these lighting systems projects a light ring or a pattern of illuminated spots—forming an LED/Laser cone/field—onto a designated area of the object. The aperture associated with this guidance light system 108 is aperture 108a.

The non-contact-type temperature sensor is strategically positioned to measure the hottest temperature within the object's highlighted region. The non-contact-type temperature sensor then transmits the electrical signal corresponding to this hottest temperature measurement via a printed circuit board 140 to either (a) an on-board memory unit (central processing unit) or (b) a remote central processing unit (collectively, referred to as 110).

The remote central processing unit can receive this “hottest object temperature's electrical signal” through several connection methods:

A wired connection system:
(i) The printed circuit board receives the signal directly from the sensor.
(ii) A standard USB-C port, electrically connected to the printed circuit board, is capable of receiving the signal.
(iii) A wire connects the central processing unit to this USB-C port, allowing the signal to be transmitted.

A first wireless connection system:
(i) The printed circuit board receives the signal from the sensor.
(ii) A conventional wireless communication device, electrically connected to the printed circuit board, receives the signal and transmits it wirelessly to the central processing unit.

A second wireless connection system:
(i) The printed circuit board receives the signal from the sensor.
(ii) A conventional USB-C port, electrically connected to both the printed circuit board and a conventional wireless communication device, receives the signal. The wireless device then transmits the signal wirelessly to the central processing unit.

A third wireless connection system;
(i) The printed circuit board receives the signal from the sensor.
(ii) A conventional USB-C port, connected to both the printed circuit board and a wire, receives the signal.
(iii) A conventional wireless communication device, connected to the wire, receives the signal and transmits it wirelessly to the central processing unit.

### Distance Measurement Device

The contact and non-contact temperature and non-contact distance sensor device 100 also incorporates a distance measurement unit 106, having an aperture identified as 106a. Typical examples of these units include ultrasonic, laser, and infrared sensors.

A standard ultrasonic sensor operates by emitting ultrasonic sound waves to determine the distance to an object. Likewise, a traditional infrared sensor measures distance using infrared waves at a specific frequency that avoids any interference with the non-contact temperature sensor's infrared waves. These infrared waves span a spectrum from 1,000 μm to 0.7 μm, which is further categorized into far infrared (1,000 μm to 15 μm), thermal infrared (15 μm to 8 μm), mid-infrared (8 μm to 3 μm), and near-infrared (3 μm to 0.7 μm) ranges.

A conventional infrared distance sensor calculates distance by analyzing triangulated reflected infrared light. For instance, a standard infrared LED emits a beam of infrared light that reflects off the intended object and is then detected by a receiver or another photosensitive component.

Another conventional laser distance sensor, sometimes referred to as a laser displacement sensor, operates through different methods. One common technique is time-of-flight, where distance is determined by measuring how long it takes for light to reflect back to the sensor. Another frequent method is triangulation, which calculates distance by analyzing the angle of the reflected laser beam.

In most instances, a conventional ultrasonic distance sensor utilizes a transducer to emit and receive ultrasonic pulses, providing information about an object's proximity. High-frequency sound waves reflect off surfaces, creating distinct echo patterns. Ultrasonic sensors function by transmitting a sound wave at a frequency beyond human hearing. The sensor's transducer acts as both a microphone and a speaker for these ultrasonic sounds. Typically, an ultrasonic sensor uses a single transducer to send a pulse and receive the resulting echo. The distance to a target is then calculated by measuring the time interval between sending and receiving the ultrasonic pulse.

The working principle of such a module is straightforward. It emits an ultrasonic pulse, typically above 20 KHz, which travels through the air. If an obstacle or object is present, the sound wave bounces back to the sensor. By measuring the travel time and knowing the speed of sound, the distance to the object can be determined.

However, in this invention, a conventional distance measurement unit does not always accurately measure the distance between (i) the top surface of the contact & non-contact temperature and non-contact distance sensors device and (ii) a specific region of an object. One reason for its difficulty is that the object used in this invention is commonly clear glass, normally heated clear glass, with rounded and/or angled surfaces. The heated glass with rounded and/or angled surfaces does not work well with conventional distance measurement devices in this invention.

It is also well known that glass is not considered, technically, a black body. A black body, as previously expressed, is an object that absorbs all incoming electromagnetic radiation. In contrast, clear glass transmits visible light and reflects some of it instead of absorbing it. And at least for that reason, a conventional distance measuring device is not always practical for this invention.

To render the contact and non-contact temperature and non-contact distance sensor device practical for most applications that involve heating a clear glass container and its contents to a desired and, preferably, specific temperature.

It is known that thermal cameras can determine a distance primarily based on the spot size ratio (SSR), which is the ratio of the distance to the spot size of the target. A higher SSR means the camera can accurately measure smaller targets from a greater distance. The camera's resolution and field of view (FOV) also play a role, as a higher resolution and narrower FOV can improve accuracy at greater distances.

The contact and non-contact temperature and non-contact distance sensor device uses a thermal sensor that (A) receives a thermal temperature signal that corresponds to the thermal energy radiating from the object—the thermal energy radiating from the object could be from (i) the contact and non-contact temperature and non-contact distance sensor device for one embodiment, (ii) a conventional heat source-like a Bunsen burner, a lighter, a heating pad, or equivalents thereof, or (iii) ambient temperature, (B) detects both the object's (i) radiated energy and (ii) reflected thermal energy to obtain the object's thermal image, and (C) identifies the object's shape, size, and distance from the contact and non-contact temperature and non-contact distance sensor device by the object's thermal image.

The identification step can be accomplished in many ways. A first way is by comparing the object's thermal image to pre-recorded images stored in a thermal sensor memory unit. The thermal sensor memory unit can be positioned (a) in the thermal sensor, (b) in the contact and non-contact temperature and non-contact distance sensor device, or (c) remote from the contact and non-contact temperature and non-contact distance sensor device.

The thermal sensor memory unit can contain various pre-recorded images of conventional heated objects heated by the contact and non-contact temperature and non-contact distance sensor device at different distances, at different temperatures, different times, and combinations thereof. The thermal sensor memory unit or processing unit receives a signal regarding the image observed by the thermal sensor and compares the received image to the pre-recorded images to determine which pre-recorded image is most similar to the received image. Based on that comparison, the thermal sensor memory unit transmits an approximate distance signal to the contact and non-contact temperature and non-contact distance sensor device's data entry portal and/or screen, so the contact and non-contact temperature and non-contact distance sensor device's data entry portal and/or screen can display an approximate distance of the object from the contact and non-contact temperature and non-contact distance sensor device. That way, the user can maintain or adjust the distance of the object (or the contact and non-contact temperature and non-contact distance sensor device) from the contact and non-contact temperature and non-contact distance sensor device (or the object) to obtain the desired distance when thermal energy is applied to the object from the contact and non-contact temperature and non-contact distance sensor device.

Alternatively, the contact and non-contact temperature and non-contact distance sensor device has a data entry portal and/or screen that can be integral to the contact and non-contact temperature and non-contact distance sensor device or remote to the contact and non-contact temperature and non-contact distance sensor device like a cell phone having an application that wirelessly communicates with the device's central processing unit. Entering the information through the data entry portal and/or screen permits a user to select the object's type or shape, size, or combinations thereof. The selected object information is converted to a signal that is transmitted to the thermal sensor memory unit that is a part of the central processing unit. The thermal sensor memory unit then limits the pre-recorded images to those pre-recorded images that correspond with the selected object information. The thermal sensor memory unit or processing unit receives the signal regarding the image observed by the thermal sensor and compares the received image to the limited pre-recorded images to determine which limited pre-recorded image is most similar to the received image. From that comparison, the thermal sensor memory unit transmits the approximate distance signal to the contact and non-contact temperature and non-contact distance sensor device, so the contact and non-contact temperature and non-contact distance sensor device can display an approximate distance of the object from the contact and non-contact temperature and non-contact distance sensor device. That way, the user can maintain or adjust the heat applied to the object based on the distance of the object (or the contact and non-contact temperature and non-contact distance sensor device) from the contact and non-contact temperature and non-contact distance sensor device (or the object).

### Guide Light Assistance

In this invention, the distance measurement unit measures the distance between the contact & non-contact temperature and non-contact distance sensors device's top surface and the object's particular region. That particular region is visually confirmed by a guide light that can be generated numerous ways, such as and not limited to: (a) the multi-colored/programmable LED ring, (b) the solid-colored LED ring, (c) the plurality of LED dot lights (for example 3 to form a triangle, 4 to form a square, et al.) or (d) the plurality of laser diodes. Those various lighting systems each transmits a light ring or a series to lighted spots onto the object's particular region. The object's particular region is where the contact & non-contact temperature and non-contact distance sensors device measures the object's temperature and distance.

The distance measurement unit (a) is positioned to measure distance between the contact & non-contact temperature and non-contact distance sensors device's top surface and the object's particular region and (b) transmits the electrical signal that corresponds to the measured distance through the printed circuit board to (a) a memory unit positioned on the printed circuit board and/or (b) a remote central processing unit. The remote central processing unit is capable of receiving the electrical signal that corresponds to the object's distance between the object's particular region and the contact & non-contact temperature and non-contact distance sensors device's top surface through:
(A) a hard connection system wherein:
(i) the printed circuit board receives the object-to-sensor's distance electrical signal since the distance sensor is electrically attached to the printed circuit board,
(ii) a conventional USB-C port that is electrically attached to the printed circuit board and therefore is capable of receiving the object-to-sensor's distance electrical signal, and
(iii) a wire that electrically interconnects the central processing unit to the USB-C port, so the object-to-sensor's distance electrical signal is capable of being received by the central processing unit.
(B) a first wireless connection system:
(i) the printed circuit board receives the object-to-sensor's distance electrical signal since the distance sensor is electrically attached to the printed circuit board,
(ii) a conventional wireless communication device; wherein the conventional wireless communication device is (a) electrically attached to the printed circuit board, (b) capable of receiving the object-to-sensor's distance electrical signal, and (c) wirelessly attached to the central processing unit, so the conventional wireless communication device is capable of transmitting the object-to-sensor's distance electrical signal to the central processing unit.
(C) a second wireless connection system:
(i) the printed circuit board receives the object-to-sensor's distance electrical signal since the distance sensor is electrically attached to the printed circuit board,
(ii) a conventional USB-C port that (a) is electrically attached to the printed circuit board and a conventional wireless communication device, and (b) capable of receiving the object-to-sensor's distance electrical signal. The conventional wireless communication device is wirelessly attached to the central processing unit, so the conventional wireless communication device is capable of transmitting the object-to-sensor's distance electrical signal to the central processing unit.
(D) a third wireless connection system:
(i) the printed circuit board receives the object-to-sensor's distance electrical signal since the distance sensor is electrically attached to the printed circuit board,
(ii) a conventional USB-C port, the conventional USB-C port is (a) electrically attached to the printed circuit board and a wire and (b) capable of receiving the object-to-sensor's distance electrical signal, and
(iii) a conventional wireless communication device is (a) electrically attached to the wire and (b) capable of receiving the object-to-sensor's distance electrical signal. The conventional wireless communication device is wirelessly attached to the central processing unit, so the conventional wireless communication device is capable of transmitting the object-to-sensor's distance electrical signal to the central processing unit.

### Other Method to Measure Distance

The distance measurement unit measures the distance between the contact & non-contact temperature and non-contact distance sensors device's upper surface and the object's particular region through a thermo-electric sensor, preferably an infrared ray array thermos-electric sensor which is a conventional device that detects, and measures infrared radiation emitted by objects, converting it into an electrical signal. It typically uses a thermopile, which is an array of thermocouples, to generate a voltage proportional to the temperature difference between the infrared radiation and the sensor itself. These sensors are commonly used for non-contact temperature measurement, presence detection, and other applications.

The infrared ray array thermos-electric sensor with an algorithm in the central processing unit is able to measure an object's temperature no matter what distance (within 2 inches to 12 inches) the thermo-electric sensor is from the object. The thermo-electric sensor has numerous pixels. The thermos-electric sensor can (a) have any number of sensor points or pixels, however, for this application thermos-electric sensor has 768 sensor points or pixels; and (b) identify which sensor points or pixels are focused on ambient room temperature areas and heated object areas. The thermos-electric sensor can also identify the pixels or sensor points that indicate the hottest area in the object's particular region that are deemed heated object areas.

The thermos-electric sensor scans each pixel (or sensor point) and transmits a pixel signal for each pixel to the central processing unit. The central processing unit receives the pixel signal and determines which pixels or sensor points are (a) above the ambient temperature threshold, (b) below the ambient temperature threshold, and, optionally but preferably, (c) the hottest area in the object's particular region.

The central processing unit then takes whatever number of pixels are above the ambient threshold and divides that pixel number by 768 (or the total number of pixels on the thermo-electric sensor) and calculates a ratio of the object's size versus the picture on the screen is the area to take the temperature.

If the central processing unit identifies that the pixels (a) above the ambient threshold—and preferably, (b) illustrating the hottest points—of the object are few—for example less than 25 pixels—, then the central processing unit recognizes that the distance between the object and the upper surface of the contact & non-contact temperature and non-contact distance sensors device is far away. Likewise, if the central processing unit identifies that the pixels (i) above the ambient threshold—and preferably, (ii) illustrating the hottest points—of the object are numerous for example over 100 pixels, then the central processing unit recognizes that the distance between the object and the upper surface of the contact & non-contact temperature and non-contact distance sensors device is close. In particular, the Applicant has calculated that when

(A) 4 pixels of the 768 pixels convey the hottest points on the object, then the Applicant is able to calculate, within a 2% error, to a first specific distance, and (B) 180 pixels of the 768 pixels convey the hottest points on the object, then the Applicant is able to calculate, within a 2% error, to a second specific distance.

For example, when the object is in close proximity, like 2 inches, to the contact & non-contact temperature and non-contact distance sensors device, then the object is identified in the thermos-electric sensor's scanned image around 40% of the pixels as non-ambient temp heated area. Of those, the hottest pixels (hottest sensor points) would be possibly 10% of the 40%. From that information, the central processing unit would recognize that based on the number of “hottest pixels” in the thermos-electric sensor's scanned image that the contact & non-contact temperature and non-contact distance sensors device is about 2 inches from the object.

And as the contact & non-contact temperature and non-contact distance sensors device moves away from the object, less of the pixels are non-ambient room temp, but more importantly, the hottest pixels will reduce in sensor points or pixels. The number of pixels that are the “hottest points” is actually the key indicator in this algorithm when finding the distance.

The central processing unit uses an algorithm that averages the number of pixels that deemed or considered the “hottest point” in the thermos-electric sensor's scanned image, and those hottest point(s) are averaged and provide the actual object temperature after the weight is established for each distance. The contact & non-contact temperature and non-contact distance sensors device will then be calibrated to use this algorithm to generate the object's actual temperature.

Thus, applicant can determine the distance between the object and the upper surface of the contact & non-contact temperature and non-contact distance sensors device just based on the number of pixels that illustrate the hottest points on the object.

In addition to determining the distance between the object and the upper surface of the contact & non-contact temperature and non-contact distance sensors device based exclusively on the number of pixels illustrating the hottest points, the Applicant can also determine the object's size and shape with accuracy.

Alternatively and not necessary for this invention, the object's size and/or shape can be pre-selected by the user on the data entry portal and/or screen which could be on the contact & non-contact temperature and non-contact distance sensors device or a remote device, like a cell phone that operates an application that interconnects the cell phone to the contact & non-contact temperature and non-contact distance sensors device. Based on the inputted object's size and the ratio of the object's size versus the picture on the screen is the area to take the temperature, the central processing unit can determine the distance of the object from the contact & non-contact temperature and non-contact distance sensors device. The calculated distance measurement (a) can be transmitted from the central processing unit to the data output screen (which can be data input screen or a distinct output screen) and (b) is used to calculate the object's actual temperature.

The actual distance measurement calculation is a multi-step process. The first step requires defining the lowest temperature point of the screen-to-object ratio (Kcom_gain=Max Temp*X %). The second step requires determining the number of temperature points (for this example 768) exceeding the minimum temperature point of the screen-to-object ratio (intT_count=0) for (int i=0; i<768 (or total number of pixels); i++) {if (Templi]>Kcom.gain)T count++}. The third step involves calculating the object screen-to-object ratio (T_count/768*100%); which allows the processor to determine the distance measurement.

Alternatively, the contact & non-contact temperature and non-contact distance sensors device is positioned a pre-determined distance from the object when the object is at ambient temperature, and the thermo-sensor device takes a thermal image reading of the ambient temperature object at that pre-determined distance. That ambient thermal image reading is transmitted to the central processing unit (or sometimes referred to as the processing unit or memory unit). The contact & non-contact temperature and non-contact distance sensors device is then positioned to a distance that allows the contact & non-contact temperature and non-contact distance sensors device to measure the thermal energy of the object when the object will be heated. And as the object's thermal image as seen by the thermo-sensor becomes smaller in relation to the ambient thermal image, and the ratio of that change permits the central processing unit to determine the distance between the contact & non-contact temperature and non-contact distance sensors device and the object. Once the distance is confirmed, the central processing unit uses the object's measured temperature, the ambient air's measured temperature and the measured distance, to calculate the object's actual temperature.

### Alternative Actual Object Temperature Calculation

The central processing unit receives the ambient temperature measurement, the object's hottest temperature measurement in a particular region, and the distance measurement between the contact & non-contact temperature and non-contact distance sensors device's top surface and the object's particular region; and calculates the object's actual temperature through an algorithm, commonly referred to as Newton's correction of temperature.

Newton's correction in the context of temperature refers to Newton's law of cooling, which states that the rate of heat loss (or gain) of a body is directly proportional to the temperature difference between the body and its surroundings. This law is used to correct for heat exchange between an object and its environment when measuring temperature changes.

The statement of Newton's law used in the heat transfer literature puts into mathematics the idea that the rate of heat loss of a body is proportional to the difference in temperatures between the body and its surroundings. For a temperature-independent heat transfer coefficient, the statement is:

q=h(T(t)−Tₑₙᵥ)(d_{c}−d), wherein
q is the heat flux transferred out of the object (watt/m²),
h is the object's heat transfer coefficient (which should be independent of T and averaged over the surface) (W/m²K), and it is recognized that the heat transfer coefficient for beaker glass (typically borosilicate glass) is around 1.38 W/m²K; and glass typically ranges from 1 W/m²K for a double-glazed low-emission window to 6 W/m²K for a single-pane glass window while understanding that a lower W/m²K-value means less heat will be lost through the glass;
T is the temperature of the object's surface,
T^{env} is the temperature of the environment; ie., the temperature suitable far from the object's surface;
d is the distance between the contact & non-contact temperature and non-contact distance sensors device's top surface and the object's particular region (m); and
d_{c} is a temperature gradient constant that could range, for example, from “5.0 to 1.0”, preferably “3.50 to 1.3” or “3.0 to 1.4”; and is dependent upon on (a) d (distance between the contact & non-contact temperature and non-contact distance sensors device's top surface and the object's particular region), (b) ambient humidity which includes the ambient water vapor—the ambient humidity can be entered by the user through the data entry portal and/or screen or obtained, through conventional wireless technology, from a third source, like the National Weather Service or a local weather information website, wherein a humidity level of 30 to 60% is average and does not alter the d_{c} value at 1.5, while a humidity level of 61% or greater raises the d_{c} value and 29% or less lowers the d_{c} value, (c) Tₑₙᵥ, and/or (d) combinations thereof.

After the central processing unit calculates the q value after receiving the information about T, Tₑₙᵥ, d, and d_{c} and assuming the object is most like a borosilicate glass unless programmed differently, and the central processing unit then adds q to T to determine the object's actual temperature (T_{act}). The actual temperature can be reported to the user.

Based on that calculation, the central processing unit transmits an approximate actual temperature signal to the contact and non-contact temperature and non-contact distance sensor device's data entry portal and/or screen, so the contact and non-contact temperature and non-contact distance sensor device's data entry portal and/or screen can display an approximate actual temperature of the object. That way, the user can maintain or adjust the heat applied to the object.

The contact & non-contact temperature and non-contact distance sensors device has a top section and bottom section. The top section is also capable of pivoting along an x-axis, a y-axis, or a combination of both the x and y-axes so the top section can be easily positioned toward the object to be measured.

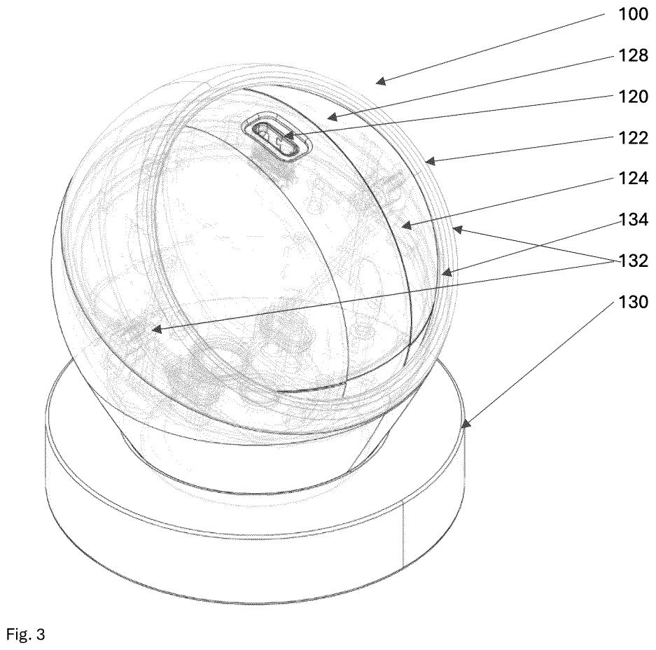

The contact & non-contact temperature and non-contact distance sensors device's upper or top surface has (a) at least one cavity or a plurality of cavities that expose the distance measurement unit, the non-contact type measurement unit, the guidance light system, and the contact type measurement unit, and (b) the guidance light system to highlight an object's particular region. Positioned below the top surface is a printed circuit board 140 as illustrated at FIG. 2. The printed circuit board electronically interconnects to each of the following units: (a) the distance measurement unit, (b) the non-contact type measurement unit, (c) the contact type measurement unit, (d) the guidance light system to highlight an object's particular region, (e) the central processing unit and/or a memory unit, (f) an optional, display unit that is capable of conveying the ambient temperature, the measured hottest temperature in the object's particular region, the distance between the object and the sensors, and/or the calculated actual hottest temperature of the object; and (g) a power source (see, for example FIG. 3).

The power source can be a battery unit, for example a lithium-ion polymer battery, and/or a conventional electrical connection that connects to a conventional power source, for example, an electrical outlet or computer that can provide the necessary power to the contact & non-contact temperature and non-contact distance sensors device to operate. The lithium-ion polymer battery can be recharged through a charging pad path from a conventional wireless charging pad and/or a conventional wireless charging plate, or through a conventional interconnection to an electrical outlet as shown in FIG. 3.

The central processing unit and/or memory unit (collectively the calculating unit) controls (a) the distance measurement unit, (b) the non-contact type measurement unit, (c) the contact type measurement unit, and (d) the desired light system to highlight an object's particular region. The controls for the central processing unit and/or memory unit are entered through a computer program and/or by conventional manual controls, for example, switches, buttons, and other conventional devices to adjust the on, off, and, if possible, intensity of each unit.

The calculating unit—as the central processing unit, the memory unit or combinations thereof—calculates the actual temperature of the object at the object's particular region by comparing the measured ambient air temperature near the upper surface to the measured object temperature in the object's particular region to make sure the measured object temperature is greater than the ambient air temperature, and adjusts the measured object temperature in relation to the measured distance to determine the object's actual temperature.

The contact & non-contact temperature and non-contact distance sensors device can also have a processing unit. The processing unit is electrically attached to a printed circuit board in the contact & non-contact temperature and non-contact distance sensors device and has a software program that can control, when the contact/non-contact temperature sensor device has been turned on, the operation of the light system, the distance measurement unit; the non-contact type measurement unit; and the contact type measurement unit. The processing unit can also be the calculating unit, a part of the calculating unit, or distinct from the calculating unit. The processing unit can be on the printed circuit board or remote from the printed circuit board and interconnected through conventional wireless technology like a Bluetooth connection. The processing unit can be pre-programmed to control the operation of the light system, the distance measurement unit; the non-contact type measurement unit; and the contact type measurement unit. The processing unit is capable of being interconnected to a program input device like a remote computer unit or cell phone. The program input device permits the software program to be edited or changed.

Also, contact/non-contact temperature sensor device could have a software application being a part of the processing unit; wherein for this embodiment the processing unit is hardwired to the printed circuit board. That software application, through artificial intelligence, writes a profile or program with custom settings written onto the contact & non-contact temperature and non-contact distance sensors device to be used without any wireless connection.

The contact & non-contact temperature and non-contact distance sensors device can have a magnetic bottom surface to permit the contact & non-contact temperature and non-contact distance sensors device to attach to metal surfaces.

The contact & non-contact temperature and non-contact distance sensors device has an exterior chamber 122 having a bottom surface 130, at least two opposing side walls (the walls can be spherical) 132 extending from the bottom surface to form a chamber opening 134; and a sensor chamber 124 pivotally attached to the exterior chamber wherein the sensor chamber has an operational side 126 and a protection side 128. Thus, when the contact & non-contact temperature and non-contact distance sensors device is able to measure the object's temperature and distance from the contact & non-contact temperature and non-contact distance sensors device, then the sensor chamber's operation side is positioned in the chamber opening, commonly referred to as the operational position. And when the contact & non-contact temperature and non-contact distance sensors device is in storage or being transported, then the sensor chamber's protection side can be positioned in chamber opening to protect the contact & non-contact temperature and non-contact distance sensors device's instruments, commonly referred to as the transportation/storage position. The user also knows that when the sensor chamber successfully pivots from (a) its operational position to its transportation/storage position, and (b) its transportation/storage position to its operational position, then the contact & non-contact temperature and non-contact distance sensors device clicks or pops since the sensor chamber and the exterior chamber, respectively, have tabs that create the sound that confirms the sensor chamber is properly positioned in the desired position.

The contact & non-contact temperature and non-contact distance sensors device can have lights that project lighting through the exterior chamber, the sensor chamber, and combinations thereof. The lighting can project various patterns including and not limited to the object's actual temperature 116.

The contact & non-contact temperature and non-contact distance sensors device can have charging station unit 120. The charging station unit can be a conventional wireless charging system unit and/or a conventional port/connector charging system unit.

The object, in many instances, for this application is commonly called a banger. And the banger, when heated, may contain herbs, cannabinoids, incense, or combinations thereof.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A contact/non-contact temperature & distance sensor device comprising:
(a) a light guidance system, the light guidance system is (i) capable of projecting light toward an object to highlight an object's particular region, and (ii) electrically attached to a printed circuit board, the printed circuit board is positioned below an upper surface of the contact/non-contact temperature & distance sensor device;
(b) a distance measurement unit, the distance measurement unit is (i) electrically attached to the printed circuit board, (ii) capable of taking a thermal image that includes the object's particular region, and (iii) capable of transmitting a first electrical signal representing the thermal image to a processing unit that can calculate the distance between the object's particular region and the upper surface based on the number of pixels in the thermal image that represent the particular region's hottest points;
(c) a non-contact type measurement unit, the non-contact type measurement unit is (i) electrically attached to the printed circuit board, (ii) capable of measuring the object's hottest temperature in the object's particular region, and (iii) capable of transmitting a second electrical signal representing the measured hottest temperature of the object at the object's particular region to the processing unit;
(d) a contact type measurement unit, the contact type measurement unit is (i) electrically attached to the printed circuit board, (ii) capable of measuring the ambient air's temperature near the contact/non-contact temperature & distance sensor device, and (iii) capable of transmitting a third electrical signal representing the measured temperature of the ambient air temperature near the upper surface to the calculating unit;
(e) the processing unit determines the object's actual hottest temperature in the particular region by (i) comparing the measured ambient air temperature to the measured hottest temperature in the object's particular region, and (ii) adjusting the measured hottest temperature in relation to the measured distance between the object's particular region and the upper surface to determine the object's actual hottest temperature.

2. The contact/non-contact temperature & distance sensor device of claim 1 further comprising a display unit capable of conveying at least one of the following:
the calculated actual hottest temperature of the object in the object's particular region;
the ambient temperature;
the measured hottest temperature in the object's particular region;
the measured distance between the object's particular region and the upper surface;
the actual hottest temperature in the object's particular region; and
combinations thereof.

3. The contact/non-contact temperature & distance sensor device of claim 1 further comprising at least one cavity, covered or not covered by a lens, on the upper surface of the contact/non-contact temperature & distance sensor device, the at least one cavity exposes:
(a) the distance measurement unit;
(b) the non-contact type measurement unit;
(c) the contact type measurement unit;
(d) the light guidance system; and
(e) combinations thereof.

4. The contact/non-contact temperature & distance sensor device of claim 1 further comprising at least four cavities in the upper surface of the contact/non-contact temperature & distance sensor device, wherein
(a) a first cavity exposes the distance measurement unit;
(b) a second cavity exposes the non-contact type measurement unit;
(c) a third cavity exposes the contact type measurement unit; and
(d) a fourth cavity exposes the light guidance system.

5. The contact/non-contact temperature & distance sensor device of claim 1, wherein the light system is selected from the group consisting of:
(a) a multi-colored/programmable LED ring, the multi-colored/programmable LED ring is capable of projecting a light cone from the contact/non-contact temperature & distance sensor device toward the object to define the particular region on the object;
(b) a single colored/programmable LED ring, the singled colored/programmable LED ring is capable of projecting a light cone from the contact/non-contact temperature & distance sensor device toward the object to define the particular region on the object;
(c) a plurality of LED dot lights, the plurality of LED dot lights are capable of projecting a plurality of light dots from the contact/non-contact temperature & distance sensor device toward the object to define the particular region on the object; and
(d) a plurality of laser diodes, the plurality of laser diodes are capable of projecting a plurality of light dots from the contact/non-contact temperature & distance sensor device toward the object to define the particular region on the object.

6. The contact/non-contact temperature & distance sensor device of claim 1, wherein the processing unit is electrically connected to the printed circuit board and has a software program that controls, when the contact/non-contact temperature & distance sensor device has been turned on, the operation of:
(a) the light system;
(b) the distance measurement unit;
(c) the non-contact type measurement unit; and
(d) the contact type measurement unit.

7. The contact/non-contact temperature & distance sensor device of claim 6, wherein the processing unit is on the printed circuit board.

8. The contact/non-contact temperature & distance sensor device of claim 6, wherein the processing unit is pre-programmed to control the operation of:
(a) the light system;
(b) the distance measurement unit;
(c) the non-contact type measurement unit; and
(d) the contact type measurement unit.

9. The contact/non-contact temperature & distance sensor device of claim 6, wherein the processing unit is capable of being interconnected to a program input device, the program input device permits the software program to be edited or changed.

10. The contact/non-contact temperature & distance sensor device of claim 1 wherein the distance measurement unit measures the distance between the upper surface and the object's particular region through a thermo-sensor device.

11. The contact/non-contact temperature & distance sensor device of claim 10 wherein the thermo-sensor device uses pixels to measure the distance between the upper surface and the object's particular region.

12. The contact/non-contact temperature sensor device of claim 10 wherein (A) the thermo-sensor device (a) is capable of being positioned to observe the object's particular region, (b) creates a thermal image, based on pixels, that includes the object's particular region, and (c) transmit the thermal image to the processing unit; and (B) wherein the processing unit (a) determines the number of pixels in the thermal image that conveys the hottest point(s) on the object's particular region, and (b) calculates the ratio of the hottest point pixels to the total number of pixels used in the thermal image, and (c) generates a measurement of the distance between the upper surface and the object's particular region.

13. The contact/non-contact temperature sensor device of claim 1, wherein the object is glass or borosilicate glass.

14. The contact/non-contact temperature sensor device of claim 13, wherein the glass or borosilicate glass has rounded surfaces.
